(19) United States
(12) Patent Application Publication
(10) Pub. No.: US 2025/0244653 A1
(43) Pub. Date: Jul. 31, 2025

(54) PROJECTION DEVICE

(71) Applicant: Qisda Corporation, Taoyuan City (TW)

(72) Inventors: Chih-Shiung Chien, Taoyuan City (TW); Ming-Kuen Lin, Taoyuan City (TW); Yi-Ling Lo, Taoyuan City (TW)

(73) Assignee: Qisda Corporation, Taoyuan City (TW)

(21) Appl. No.: 19/017,790

(22) Filed: Jan. 13, 2025

(30) Foreign Application Priority Data
Jan. 29, 2024 (TW) 113103397

(51) Int. Cl. G03B 21/20; G02B 27/28

(52) U.S. Cl. CPC G03B 21/2073; G02B 27/283; G03B 21/2033; G03B 21/2066; G03B 21/208

(57) ABSTRACT

A projection device includes a light source device including a light source, a light splitting element, a quarter wave plate, a reflective element. The light source emits an illumination beam having at least two different colors of light and a first linear polarization direction. The light splitting element, the quarter wave plate, the reflective element are on a transmission path of the illumination beam. After the illumination beam passes through the light splitting element, the illumination beam is incident on the quarter wave plate and the reflective element in sequence. After being reflected by the reflective element, the illumination beam passes through the quarter wave plate and the light splitting element in sequence. When the illumination beam passes through the quarter wave plate via the light splitting element, the illumination beam has a second linear polarization direction. The first linear polarization direction is perpendicular to the second linear polarization direction.

### CROSS-REFERENCE TO RELATED APPLICATION

This application claims the priority benefit of Taiwan application serial no. 113103397, filed on Jan. 29, 2024. The entirety of the above-mentioned patent application is hereby incorporated by reference herein and made a part of specification.

### BACKGROUND OF THE INVENTION

### Field of the Invention

The invention relates to a projection device.

### Description of Related Art

In a projection system, high-quality projected images have wide application value. Therefore, it has become an important issue in the art to efficiently generate a plurality of high-quality colors of light and simultaneously meet the requirements of reducing system volume and cost.

### SUMMARY OF THE INVENTION

The invention provides a projection device including: a light source device, wherein the light source device includes: a light source, a light splitting element, a quarter wave plate, and a reflective element, wherein the light source is used to emit an illumination beam, the illumination beam has at least two different colors of light, and the illumination beam has a first linear polarization direction. The light splitting element, the quarter wave plate, and the reflective element are located on a transmission path of the illumination beam. After the illumination beam passes through the light splitting element, the illumination beam is incident on the quarter wave plate and the reflective element in sequence, and after being reflected by the reflective element, the illumination beam passes through the quarter wave plate and the light splitting element in sequence, wherein when the illumination beam passes through the quarter wave plate via the light splitting element, the illumination beam has a second linear polarization direction, and the first linear polarization direction is perpendicular to the second linear polarization direction.

In an embodiment of the invention, the light splitting element is used to reflect the illumination beam having the first linear polarization direction and used to let the illumination beam having the second linear polarization direction pass through.

In an embodiment of the invention, the light source and the reflective element are located at a same side of the light splitting element.

In an embodiment of the invention, the light splitting element is used to let the illumination beam having a first linear polarization direction pass through and used to reflect the illumination beam having a second linear polarization direction.

In an embodiment of the invention, the light source and the reflective element are located at two sides of the light splitting element respectively.

In an embodiment of the invention, the projection device further includes: a homogenizing element disposed on the transmission path of the illumination beam and located between the light splitting element and the quarter wave plate, and the homogenizing element is used to homogenize the illumination beam incident on the homogenizing element.

In an embodiment of the invention, the homogenizing element is a fly eye lens.

In an embodiment of the invention, the projection device further includes: a homogenizing element disposed on the transmission path of the illumination beam and located between the quarter wave plate and the reflective element, and the homogenizing element is used to homogenize the illumination beam incident on the homogenizing element.

In an embodiment of the invention, the homogenizing element is a light guide pillar.

In an embodiment of the invention, the light guide pillar is hollow or solid.

In an embodiment of the invention, an opening area of the light guide pillar at the reflective element side is A1 and an opening area of the light guide pillar at another side is A2, and A1≥A2.

In an embodiment of the invention, a surface of the reflective element has a diffusion device.

In an embodiment of the invention, the reflective element is located at an end opposite to a light incident side of the homogenizing element.

In an embodiment of the invention, the projection device further includes a diffusion sheet located between the quarter wave plate and the homogenizing element.

In an embodiment of the invention, the illumination beam includes two or more of a red light, a blue light, and a green light.

In an embodiment of the invention, the projection device further includes: a refractive element, a light valve, and a projection lens, wherein after the illumination beam passes through the refractive element, the illumination beam is incident on the light valve, the light valve converts the illumination beam into the image beam, and the projection lens is disposed on an optical path of the image beam.

In an embodiment of the invention, the refractive element is a lens or curved mirror having a positive refractive power.

In an embodiment of the invention, the projection device further includes a refractor, wherein the refractor is located on an optical path of the illumination beam, and the refractor is located between the light splitting element and the refractive element.

In an embodiment of the invention, when the illumination beam is incident on the homogenizing element via the light splitting element, the illumination beam is imaged at the reflective element, and when the illuminating beam is incident on the homogenizing element via the reflective element, the illuminating beam is imaged at the light valve.

In an embodiment of the invention, the projection device further includes a total reflection lens, wherein the total reflection lens is located on an optical path of the illumination beam, and the total reflection lens is located between the refractive element and the light valve.

Based on the above, the projection device provided by the invention may generate an illumination beam having a plurality of colors of light at the same time, an illumination beam having a single polarization direction is generated via the light splitting element, and the optical path is changed via the reflective element and the homogenizing element, and the illumination beam is shaped. The light valve converts the illumination beam into a color image beam to project the desired image. Via the above configuration, the effect of simplified optical path and reduced system size may be achieved.

### BRIEF DESCRIPTION OF THE DRAWINGS

FIG. 1A is a schematic diagram of a light source device according to an embodiment of the invention.

FIG. 1B is a schematic diagram of a light source device according to an embodiment of the invention.

FIG. 2 is a schematic diagram of a light source device according to an embodiment of the invention.

FIG. 3A and FIG. 3B are schematic diagrams of a light source device according to an embodiment of the invention.

FIG. 4 is a schematic diagram of a projection device according to an embodiment of the invention.

FIG. 5A and FIG. 5B are schematic diagrams of a projection device according to an embodiment of the invention.

FIG. 6 is a schematic diagram of a projection device according to an embodiment of the invention.

FIG. 7 is a schematic diagram of a projection device according to an embodiment of the invention.

### DESCRIPTION OF THE EMBODIMENTS

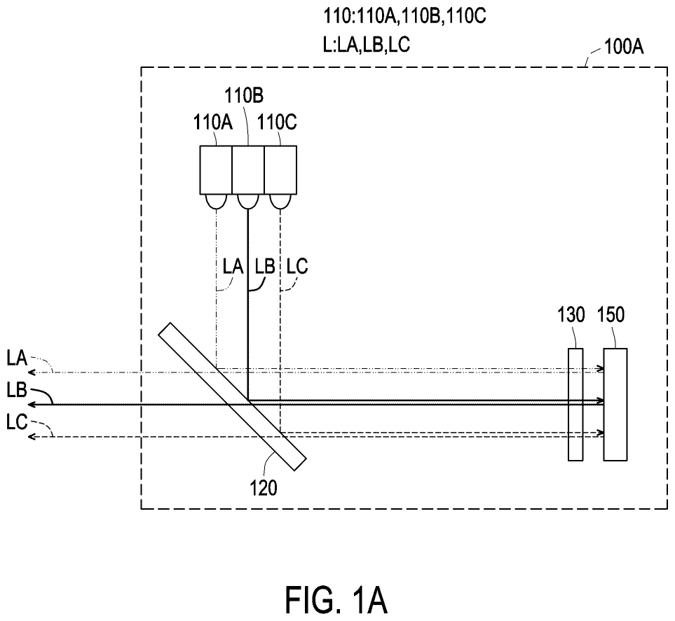

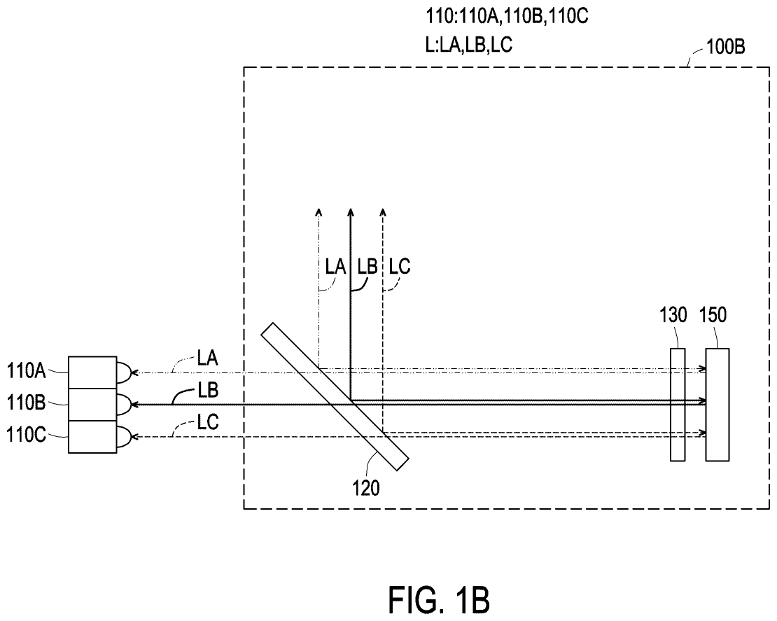

FIG. 1A is a schematic diagram of a light source device according to an embodiment of the invention. Please refer to FIG. 1A. The invention provides a projection device, including: a light source device 100A. The light source device 100A includes: a light source 110, a light splitting element 120, a quarter wave plate 130, and a reflective element 150.

The light source 110 is used to emit an illumination beam L, and the illumination beam L has at least two different colors of light. As shown in FIG. 1A, the light source 110 includes a first light source 110A used to emit a first color of light LA; a second light source 110B used to emit a second color of light LB different from the first color of light LA; and a third light source 110C used to emit a third color of light LC different from the first color of light LA and the second color of light LB. The first color of light LA, the second color of light LB, and the third color of light LC are combined into the illumination beam L. To simplify the description, in the following description, the light source 110 includes the first light source 110A, the second light source 110B, and the third light source 110C. The illumination beam L includes the first color of light LA, the second color of light LB, and the third color of light LC.

In the present embodiment, the light source 110 contains three light sources that may emit different colors of light. In some embodiments, the first light source 110A, the second light source 110B, and the third light source 110C may be laser light sources, and the first color of light LA is red light, the second color of light LB is green light, and the third color of light LC is blue light. For example, the first light source 110A may include a plurality of red laser diodes arranged in an array, the second light source 110B may include a plurality of green laser diodes arranged in an array, and the third light source 110C may include a plurality of blue laser diodes arranged in an array, but the disclosure is not limited thereto. In some embodiments, the light source 110 may contain a light source emitting two or more different colors of light, such as two, or more than three, depending on actual needs, and the disclosure is not limited thereto. In some embodiments, the illumination beam L includes two or more of red light, blue light, and green light.

In some embodiments, the first light source 110A, the second light source 110B, and the third light source 110C of the light source 110 may emit beams having a specific polarization direction, that is, having a first linear polarization direction, such as emitting a beam having a polarization direction of S polarization, or emitting a beam having a polarization direction of P polarization. In the present embodiment, the first color of light LA, the second color of light LB, and the third color of light LC emitted by the first light source 110A, the second light source 110B, and the third light source 110C of the light source 110 all have the same polarization direction. For example, the first color of light LA, the second color of light LB, and the third color of light LC having a polarization direction of S polarization may be emitted to form the illumination beam L having a polarization direction of S polarization.

As shown in FIG. 1A, the light splitting element 120, the quarter wave plate 130, and the reflective element 150 are located on the transmission path of the illumination beam L. After the illumination beam L passes through the light splitting element 120, the illumination beam L is incident on the quarter wave plate 130 and the reflective element 150 in sequence. After being reflected by the reflective element 150, the illumination beam L passes through the quarter wave plate 130 and the light splitting element 120 in sequence, wherein when the illumination beam L passes through the quarter wave plate 130 via the light splitting element 120, the illumination beam L has a second linear polarization direction, and the first linear polarization direction is perpendicular to the second linear polarization direction.

Specifically, the illumination beam L emitted by the light source 110 is incident on the light splitting element 120. In the present embodiment, the light splitting element 120 is used to reflect an incident light having a first linear polarization direction and to let an incident light having a second linear polarization direction pass through. In the present embodiment, the first linear polarization direction is S polarization, and the second linear polarization direction is P polarization. Therefore, in the present embodiment, the light splitting element 120 is used to reflect an incident light having S polarization and let an incident light having P polarization pass through. In the present embodiment, the incident light is the illumination beam L.

Therefore, in the present embodiment, after the illumination beam L having S polarization emitted by the light source 110 is incident on the light splitting element 120, the illumination beam L is reflected by the light splitting element 120. In another embodiment, if the excitation beam emitted by the light source 110 has both S polarization and P polarization, the illumination beam L having P polarization passes through the light splitting element 120 and leaves the system.

In other embodiments, the first linear polarization direction may be P polarization, and the second linear polarization direction may be S polarization. That is, the light splitting element 120 is used to reflect an incident light having P polarization and let an incident light having S polarization pass through.

The illumination beam L reflected by the light splitting element 120 is incident on the quarter wave plate 130 and the reflective element 150 in sequence, so the light source 110 and the reflective element 150 are located at the same side of the light splitting element 120.

The illumination beam L reflected by the light splitting element 120 is incident on the quarter wave plate 130 located on the optical path, such that the polarization direction of the illumination beam L is changed from the first linear polarization direction to circular polarization, and then the illumination beam L is incident on the reflective element 150.

In some embodiments, the reflective element 150 is used to reflect the illumination beam L, such that the illumination beam L passes through the quarter wave plate 130 and the light splitting element 120 in sequence. In some embodiments, the reflective element 150 is a specular reflective element, and the specular reflective element may be reflective glass used to simultaneously reflect red light, green light, and blue light. According to some other embodiments, the material of the reflective element 150 may be a metal coating, such as silver, aluminum, dielectric coating, etc., having a thickness less than 5 μm. In some embodiments, the surface of the reflective element 150 has a diffusion device, such as a microstructure or the like having a similar function, but the disclosure is not limited thereto.

The illumination beam L emitted by the reflective element 150 is incident on the quarter wave plate 130 along the optical path. At this time, the polarization direction in the illumination beam L is changed from circular polarization to linear polarization again. However, at this time, the linear polarization direction of the illumination beam L emitted by the light source 110 is changed from S polarization to P polarization, that is, the second linear polarization direction, and the first linear polarization direction is perpendicular to the second linear polarization direction.

The illumination beam L passing through the quarter wave plate 130 is incident on the light splitting element 120 along the optical path. Since the illumination beam L has P polarization at this time, and the light splitting element 120 may let an incident beam having P polarization pass through, the illumination beam L passes through the light splitting element 120 and proceeds along the optical path.

Therefore, via the light source device 100A shown in FIG. 1, the illumination beam L may be emitted using the light source 110 that may emit two or more colors of light, and using the light splitting element 120, the illumination beam L may have the same polarization direction and the optical path of the illumination beam L may be changed.

FIG. 1B is a schematic diagram of a light source device according to an embodiment of the invention. A light source device 100B shown in FIG. 1B is similar to the light source device 100A shown in FIG. 1A, so the similarities are not described again. The difference between the light source device 100B shown in FIG. 1B and the light source device 100A shown in FIG. 1A is that the polarization direction of the illumination beam L emitted by the light source 110 is P polarization. Therefore, when the illumination beam L is incident on the light splitting element 120, the illumination beam L passes through the light splitting element 120, and passes through the quarter wave plate 130 and the reflective element 150 in sequence, and returns to the light splitting element 120 along the original optical path. And when the illumination beam L passes through the light splitting element 120, after the illumination beam L having P polarization passes through the quarter wave plate 130 twice, the illumination beam L has S polarization, and therefore the illumination beam L may be reflected by the light splitting element 120 and continue along the optical path.

In the present embodiment, the light source 110 is located at a side of the light splitting element 120, and the quarter wave plate 130 and the reflective element 150 are both located at another opposite side of the light splitting element 120.

Therefore, an appropriate light source device may be selected according to whether the linear polarization direction of the light needed by the system is S polarization or P polarization, as shown in the light source device 100A of FIG. 1A or the light source device 100B of FIG. 1B.

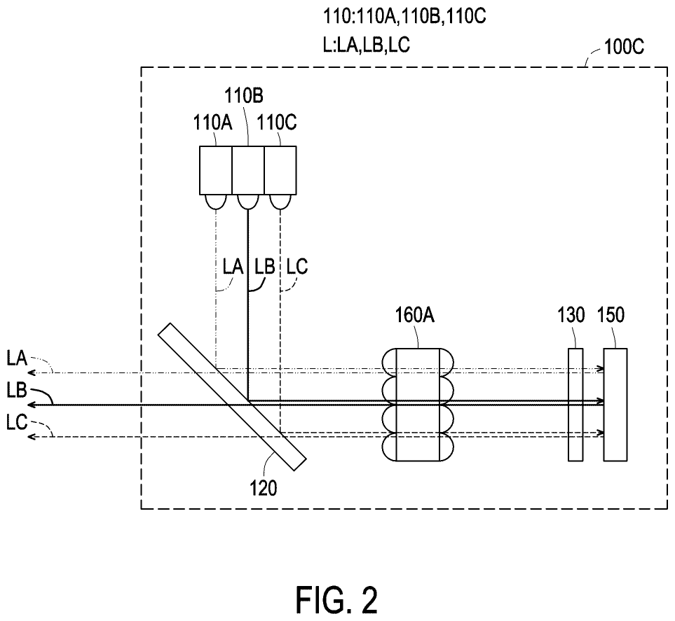

FIG. 2 is a schematic diagram of a light source device according to an embodiment of the invention. A light source device 100C shown in FIG. 2 is similar to the light source device 100A shown in FIG. 1A, so the similarities are not described again. The difference between the light source device 100C shown in FIG. 2 and the light source device 100A shown in FIG. 1A is that the light source device 100C further includes a homogenizing element 160A disposed on the transmission path of the illumination beam L and located between the light splitting element 120 and the reflective element 150. In some embodiments, the homogenizing element 160A is located between the light splitting element 120 and the quarter wave plate 130. In other embodiments, the homogenizing element 160A may also be located between the quarter wave plate 130 and the reflective element 150, and the disclosure is not limited thereto. The homogenizing element 160A is used to homogenize the illumination beam L incident on the homogenizing element 160A. Therefore, when the illumination beam L is emitted from the light source 110 and enters the homogenizing element 160A, the quarter wave plate 130, and the reflective element 150 in sequence, the reflective element 150 is located at an end opposite to the light incident side of the homogenizing element 160A, that is, the light exit side of the homogenizing element 160A.

Specifically, when the illumination beam L enters the homogenizing element 160A, the illumination beam L may be shaped via the homogenizing element 160A. For example, the illumination beam L having a circular light spot emitted by the light source 110 is changed into a rectangular light spot, and the shaped illumination beam L passes through the quarter wave plate 130 and is incident on the reflective element 150. Moreover, when the illumination beam L is reflected via the reflective element 150 and then passes through the homogenizing element 160A, the homogenizing element 160A may shape the illumination beam L reflected by the reflective element 150 for a second time, such that the illumination beam L has a desired shape.

Therefore, in the present embodiment, the illumination beam L including the first color of light LA, the second color of light LB, and the third color of light LC passes through the homogenizing element 160A twice, that is, is shaped twice.

In some embodiments, the homogenizing element 160A is a fly eye, or has other similar functions, but the disclosure is not limited thereto.

In some embodiments, the homogenizing element 160A may also be disposed at a similar position to the light source device 100B of FIG. 1B.

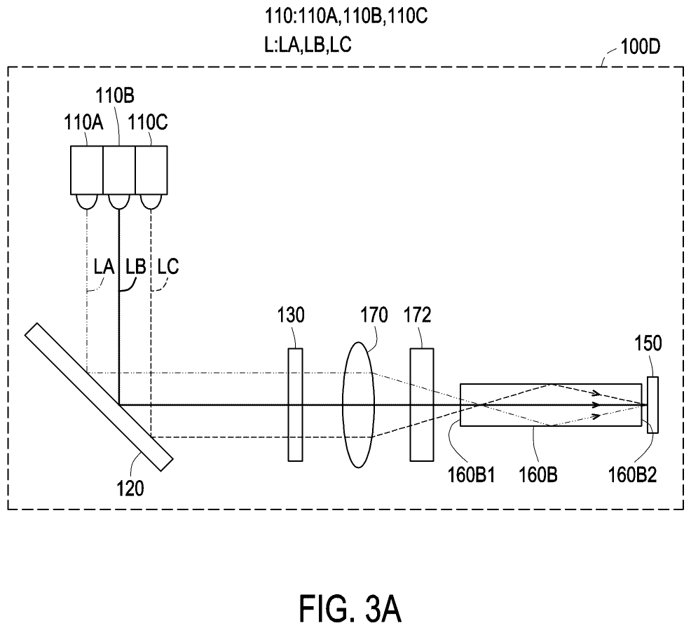

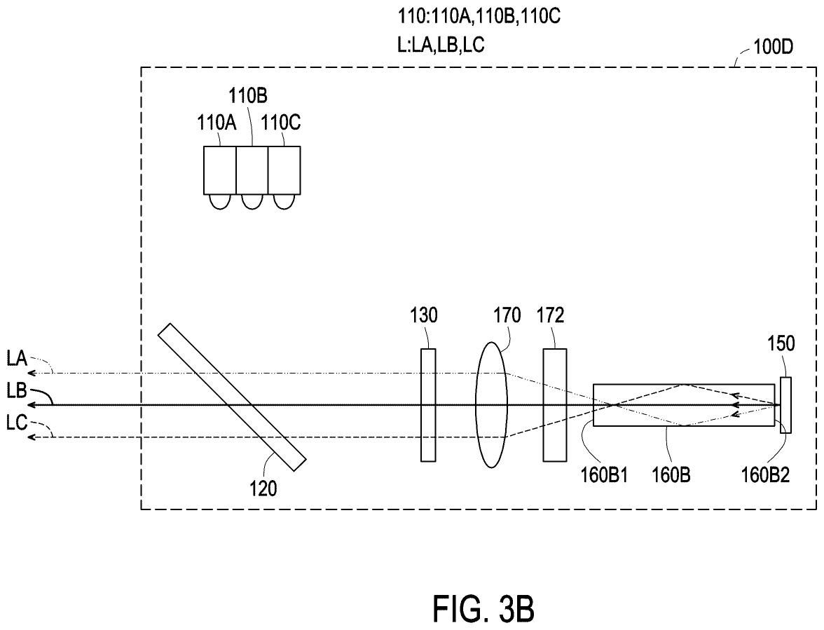

FIG. 3A and FIG. 3B are schematic diagrams of a light source device according to an embodiment of the invention. FIG. 3A and FIG. 3B show a same light source device 100D, wherein FIG. 3A shows the optical path of the illumination beam L emitted from the light source 110 and incident on the reflective element 150, and FIG. 3B shows the optical path of the illumination beam L after the illumination beam L is reflected by the reflective element 150, such that the optical path of the illumination beam L is clearly identifiable.

The light source device 100D shown in FIG. 3A and FIG. 3B is similar to the light source device 100A shown in FIG. 1A, so the similarities are not described again. The difference between the light source device 100D shown in FIG. 3A and FIG. 3B and the light source device 100A shown in FIG. 1A is that the light source device 100C further includes a homogenizing element 160B disposed on the transmission path of the illumination beam L and located between the quarter wave plate 130 and the reflective element 150. The homogenizing element 160B is used to homogenize the illumination beam L incident on the homogenizing element 160B. Therefore, when the illumination beam L is emitted from the light source 110 and enters the homogenizing element 160B and the reflective element 150 in sequence, the reflective element 150 is located at an end opposite to the light incident side of the homogenizing element 160B, that is, the light exit side of the homogenizing element 160B.

Specifically, when the illumination beam L enters the homogenizing element 160B, the illumination beam L may be shaped via the homogenizing element 160B. For example, the illumination beam L having a circular light spot emitted by the light source 110 is changed into a rectangular light spot, and the shaped illumination beam L passes through the quarter wave plate 130 and is incident on the reflective element 150. Moreover, when the illumination beam L is reflected via the reflective element 150 and then passes through the homogenizing element 160B, the homogenizing element 160B may shape the illumination beam L reflected by the reflective element 150 for a second time, such that the illumination beam L has a desired shape.

Therefore, in the present embodiment, the illumination beam L including the first color of light LA, the second color of light LB, and the third color of light LC passes through the homogenizing element 160B twice, that is, is shaped twice.

In some embodiments, the homogenizing element 160B is a light guide pillar, or has other similar functions, but the disclosure is not limited thereto. In some embodiments, the homogenizing element 160B, i.e., the light guide pillar, is hollow or solid.

In some embodiments, the area of an opening 160B1 of the light guide pillar at the reflective element 150 side is A1, and the area of an opening 160B2 at the reflective element 150 side is A2, and A1≥A2. Therefore, when the illumination beam L is incident on the homogenizing element 160B, in addition to shaping, there is also a converging effect.

In some embodiments, the reflective element 150 may be located at the opening 160B2 of the homogenizing element 160B and combined with the homogenizing element 160B to reduce the escape of light generated when the illumination beam L is incident on the reflective element 150 via the homogenizing element 160B, thereby improving the reflection efficiency of the illumination beam L at the reflective element 150.

In some embodiments, the homogenizing element 160B may also be disposed at a similar position to the light source device 100B of FIG. 1B.

As shown in FIG. 3A and FIG. 3B, the light source device 100D further includes a lens 170 located between the quarter wave plate 130 and the homogenizing element 160B. The lens 170 generally refers to a lens having a light converging function used to change the characteristics of the illumination beam L.

As shown in FIG. 3A and FIG. 3B, the light source device 100D further includes a diffusion sheet 172 located between the quarter wave plate 130 and the homogenizing element 160B. The diffusion sheet 172 is used to change the shape of the illumination beam L. In some embodiments, the surface of the diffusion sheet 172 includes a microstructure or a diffusion particle, or one with similar functions.

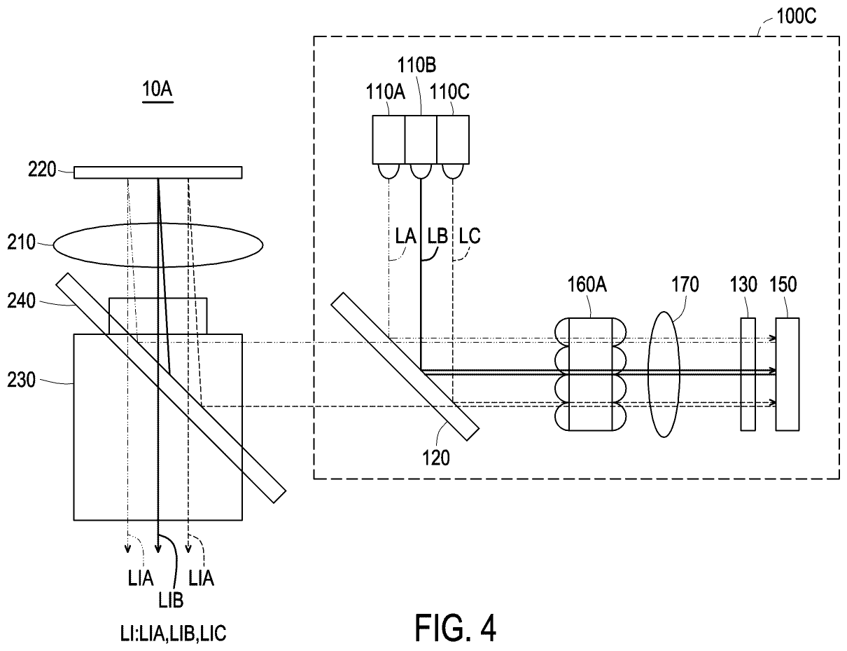

FIG. 4 is a schematic diagram of a projection device according to an embodiment of the invention. Please refer to FIG. 4. A projection device 10A of FIG. 4 includes the light source device 100C used to generate the illumination beam L. In particular, the light source device 100C may also be any of the light source device 100A shown in FIG. 1A, the light source device 100B shown in FIG. 1B, or the light source device 100D shown in FIG. 3A and FIG. 3B, and the disclosure is not limited thereto.

In the present embodiment, the light source device 100C further includes the lens 170 located between the homogenizing element 160A and the quarter wave plate 130 and used to change the optical characteristics of the illumination beam L.

As shown in FIG. 4, the projection device 10A further includes: a refractive element 210, a light valve 220, and a projection lens 230. The illumination beam L emitted by the light source device 100C passes through the refractive element 210 and then is incident on the light valve 220. The light valve 220 converts the illumination beam L into the image beam LI, and the projection lens 230 is disposed on the optical path of the image beam LI.

Specifically, the refractive element 210 generally refers to a lens having a light converging function, such that the illumination beam L may be projected on the light valve 220. Specifically, in some embodiments, the refractive element 210 is a lens having positive refractive power.

In the present embodiment, the illumination beam L emitted by the light source device 100C is first incident on a refractor 240 before being incident on the refractive element 210. The refractor 240 is located on the optical path of the illumination beam L. The refractor 240 is located between the light splitting element 120 and the refractive element 210 and used to change the optical path of the illumination beam L. In some embodiments, the refractor 240 may be a plane reflector, a curved reflector, or one with similar functions, but the disclosure is not limited thereto.

The illumination beam L is reflected by the refractor 240, passes through the refractive element 210, and then is incident on the light valve 220. The light valve 220 is suitable for converting the illumination beam L into the image beam LI. Specifically, the light valve 220 converts the first color of light LA, the second color of light LB, and the third color of light LC in the illumination beam L into a first image beam LIA, a second image beam LIB, and a third image beam LIC respectively, wherein the first image beam LIA, the second image beam LIB, and the third image beam LIC form the image beam LI. In the present embodiment, the light valve 220 is, for example, a digital micro-mirror device (DMD) or a liquid-crystal-on-silicon panel (LCOS panel). However, in other embodiments, the light valve 220 may also be a transmissive liquid-crystal panel or other beam modulator.

In addition, when the illumination beam L is incident on the homogenizing element 160A via the reflective element 150, the illumination beam L is imaged at the light valve 220.

The projection lens 230 is located on the transmission path of the image beam LI and suitable for projecting the image beam LI onto a screen (not shown) to form an image screen. In the present embodiment, the projection lens 230 includes a combination of one or a plurality of optical lenses having a diopter, and the optical lens includes, for example, various combinations of a non-planar lens such as a biconcave lens, a lenticular lens, a concave-convex lens, a convex-concave lens, a plano-convex lens, and a plano-concave lens. The invention does not limit the configuration and the type of the projection lens 230.

Since after the illumination beam L is converged on the light valve 220, the light valve 220 sequentially converts the different colors of light in the illumination beam L into corresponding image beams LI and transmits the corresponding image beams LI to the projection lens 230, the image screen projected by the image beam LI converted by the light valve 220 may become a color screen.

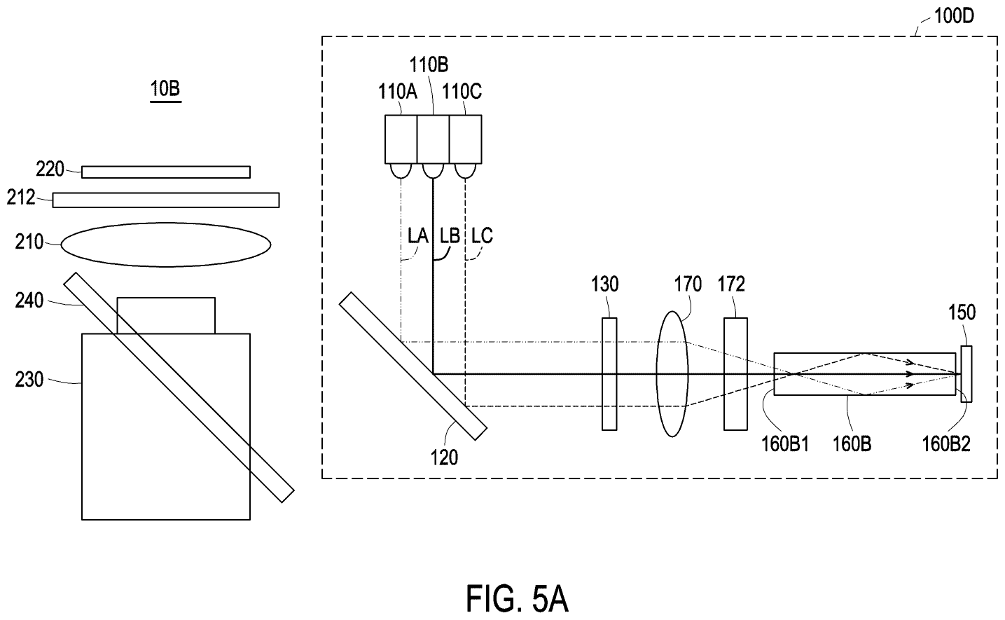

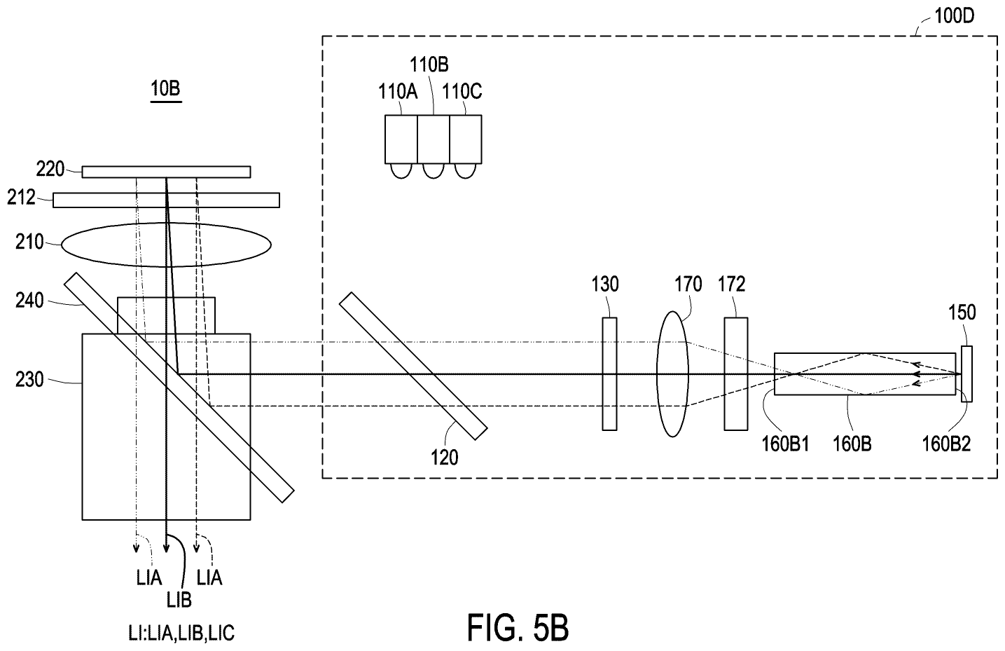

FIG. 5A and FIG. 5B are schematic diagrams of a projection device according to an embodiment of the invention. FIG. 5A and FIG. 5B show a same projection device 10B, wherein FIG. 5A shows the optical path of the illumination beam L emitted from the light source 110 and incident on the reflective element 150, and FIG. 5B shows the optical path of the illumination beam L after the illumination beam L is reflected by the reflective element 150, such that the optical path of the illumination beam L is clearly identifiable.

The projection device 10B shown in FIG. 5A and FIG. 5B is similar to the projection device 10A shown in FIG. 4, so the similarities are not described again. The difference between the projection device 10B shown in FIG. 5A and FIG. 5B and the projection device 10A shown in FIG. 4 is that in FIG. 5A and FIG. 5B, the light source device is the light source device 100D. The projection device 10B further includes an optical actuator 212. The illumination beam L is reflected by the refractor 240, passes through the optical actuator 212, and then is incident on the light valve 220. The image beam LI passes through the repeatedly vibrating lens on the optical actuator 212 to increase image resolution.

In addition, when the illumination beam L is incident on the homogenizing element 160B via the reflective element 150, the illumination beam L is imaged at the light valve 220.

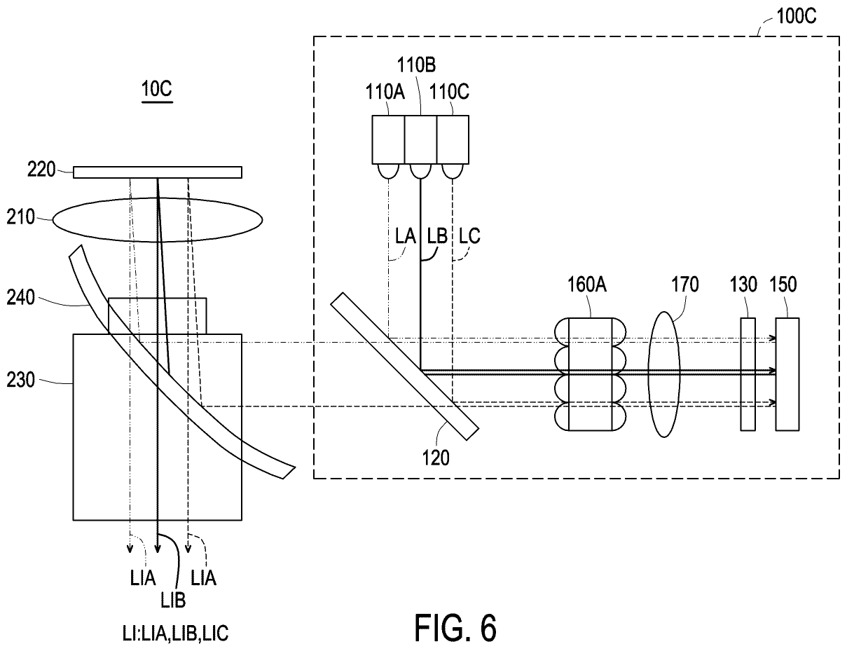

FIG. 6 is a schematic diagram of a projection device according to an embodiment of the invention. A projection device 10C shown in FIG. 6 is similar to the projection device 10A shown in FIG. 4, so the similarities are not described again. The difference between the projection device 10C shown in FIG. 6 and the projection device 10A shown in FIG. 4 is that in FIG. 6, the refractive element 210 is a curved mirror having positive refractive power. When the illumination beam L is reflected by the refractive element 210, the illumination beam L is incident on the light valve 220. The light valve 220 converts the illumination beam L into the image beam LI, and then the image beam LI is incident on the projection lens 230.

Therefore, via the refractive element 210, the effect of changing the optical path of the illumination beam L may be achieved.

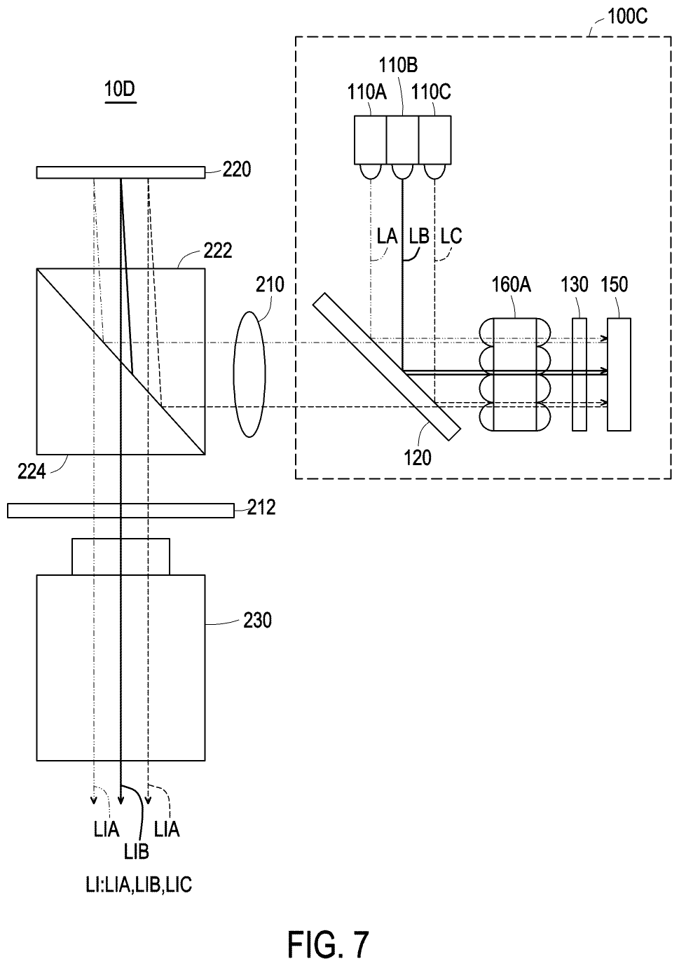

FIG. 7 is a schematic diagram of a projection device according to an embodiment of the invention. A projection device 10D shown in FIG. 7 is similar to the projection device 10A shown in FIG. 4, so the similarities are not described again. The difference between the projection device 10D shown in FIG. 7 and the projection device 10A shown in FIG. 4 is that the projection device 10D further includes a total reflection lens 222. The total reflection lens 222 is located on the optical path of the illumination beam L and located between the refractive element 210 and the light valve 220. After the illumination beam L passes through the refractive element 210, the illumination beam L is incident on the total reflection lens 222.

The total reflection lens 222 is in the shape of a right-angled triangle. The illumination beam L is incident on the total reflection lens 222, is totally reflected by the long side of the total reflection lens 222, and then is incident on the light valve 220. After the light valve 220 converts the illumination beam L into the image beam LI, the image beam LI is totally reflected by the total reflection lens 222 and passes through the lens 224, and then is incident on the projection lens 230.

Therefore, via the combination of the total reflection lens 222 and the lens 224, the effect of changing the optical path of the illumination beam L and the image beam LI may be achieved.

Based on the above, the projection device provided by the invention may generate an illumination beam having a plurality of colors of light at the same time, an illumination beam having a single polarization direction is generated via a light splitting element, and the optical path is changed via the reflective element and the homogenizing element, and the illumination beam is shaped. The light valve converts the illumination beam into a color image beam to project the desired image. Via the above configuration, the effect of simplified optical path and reduced system size may be achieved.

What is claimed is:

1. A projection device, comprising: a light source device,
wherein the light source device comprises: a light source, a light splitting element, a quarter wave plate, a reflective element, and a homogenizing element, wherein,
the light source is used to emit an illumination beam, wherein the illumination beam has at least two different colors of light, the illumination beam has a first linear polarization direction, and the light splitting element, the quarter wave plate, and the reflective element are located on a transmission path of the illumination beam;
after the illumination beam passes through the light splitting element, the illumination beam is incident on the quarter wave plate and the reflective element in sequence, and after being reflected by the reflective element, the illumination beam passes through the quarter wave plate and the light splitting element in sequence, wherein when the illumination beam passes through the quarter wave plate via the reflecting element, the illumination beam has a second linear polarization direction, and the first linear polarization direction is perpendicular to the second linear polarization direction,
the homogenizing element is disposed on the transmission path of the illumination beam and located between the light splitting element and the reflecting element, and the homogenizing element is used to homogenize the illumination beam incident on the homogenizing element, and the illumination beam passes through the homogenizing element twice.

2. The projection device of claim 1, wherein the light splitting element is used to reflect the illumination beam having the first linear polarization direction and used to let the illumination beam having the second linear polarization direction pass through.

3. The projection device of claim 2, wherein the light source and the reflective element are located at a same side of the light splitting element.

4. The projection device of claim 1, wherein the light splitting element is used to let the illumination beam having a first linear polarization direction pass through and used to reflect the illumination beam having a second linear polarization direction.

5. The projection device of claim 2, wherein the light source and the reflective element are respectively located at two sides of the light splitting element.

6. The projection device of claim 1, wherein
the homogenizing element is located between the light splitting element and the quarter wave plate.

7. The projection device of claim 6, wherein the homogenizing element is a fly eye lens.

8. The projection device of claim 1, wherein
the homogenizing element is located between the quarter wave plate and the reflective element.

9. The projection device of claim 8, wherein the homogenizing element is a light guide pillar.

10. The projection device of claim 9, wherein the light guide pillar is hollow or solid.

11. The projection device of claim 9, wherein an opening area of the light guide pillar at the reflective element side is A1 and an opening area of the light guide pillar at another side is A2, and A1≥A2.

12. The projection device of claim 8, wherein a surface of the reflective element has a diffusion device.

13. The projection device of claim 8, wherein the reflective element is located at an end opposite to a light incident side of the homogenizing element.

14. The projection device of claim 8, further comprising a diffusion sheet located between the quarter wave plate and the homogenizing element.

15. The projection device of claim 8, wherein the illumination beam comprises two or more of a red light, a blue light, and a green light.

16. The projection device of claim 1, further comprising: a refractive element, a light valve, and a projection lens, wherein after the illumination beam passes through the refractive element, the illumination beam is incident on the light valve, the light valve converts the illumination beam into an image beam, and the projection lens is disposed on the transmission path of the image beam.

17. The projection device of claim 16, wherein the refractive element is a lens or a curved mirror having a positive refractive power.

18. The projection device of claim 16, further comprising a refractor, wherein the refractor is located on the transmission path of the illumination beam, and the refractor is located between the light splitting element and the refractive element.

19. The projection device of claim 16, wherein
the homogenizing element is located between the quarter wave plate and the reflective element,
when the illumination beam is incident on the homogenizing element via the light splitting element, the illumination beam is imaged at the reflective element,
when the illumination beam is incident on the homogenizing element via the reflective element, the illumination beam is imaged at the light valve.

20. The projection device of claim 16, further comprising a total reflection lens, wherein the total reflection lens is located on the transmission path of the illumination beam, and the total reflection lens is located between the refractive element and the light valve.
